(19) United States
(12) Patent Application Publication
(10) Pub. No.: US 2018/0164731 A1
(43) Pub. Date: Jun. 14, 2018

(54) SHEET SUPPORTING APPARATUS AND IMAGE FORMING APPARATUS

(71) Applicant: CANON KABUSHIKI KAISHA, Tokyo (JP)

(72) Inventor: Masayuki Tokumoto, Kashiwa-shi (JP)

(21) Appl. No.: 15/826,948

(22) Filed: Nov. 30, 2017

(30) Foreign Application Priority Data
Dec. 12, 2016 (JP) 2016-240536

(51) Int. Cl. G03G 15/00

(52) U.S. Cl. CPC G03G 15/6567; G03G 15/6502

(57) ABSTRACT

A sheet supporting apparatus includes a sheet supporting portion and a pair of regulating portions provided on the sheet supporting portion. At least one of the pair of regulating portions includes an abutment surface configured to be abuttable with the sheet in the width direction and an extension configured to extend from the abutment surface to a side in which the abutment surface abuts with the sheet. The support surface of the sheet supporting portion is bent in a support direction which is a direction orthogonal to the conveyance direction and the width direction at a position corresponding to the extension in the conveyance direction.

### BACKGROUND OF THE INVENTION

### Field of the Invention

The present disclosure relates to a sheet supporting apparatus configured to support a sheet.

### Description of the Related Art

Lately, with an increase and diversification of types of sheets to be fed in an Image forming apparatus, a tray configured to support and to supply a small number of various size sheets is often provided on an outside of an apparatus body. Such tray configured to supply the various size sheets is provided with a side regulating plate configured to be movable in a width direction which is a direction orthogonal to a conveyance direction of the sheet and to abut with the sheet in the width direction to regulate a widthwise position of the sheet.

Concerning the tray including the side regulating plate, it is known such a problem that a sheet supported by the tray enters a gap or a play generated between a body of the tray and the side regulating plate in moving the side regulating plate toward a widthwise inner side. Hitherto, as an arrangement for preventing the sheet from slipping into the gap between the tray body and the side regulating plate, Japanese Patent Application Laid-open No. 2014-47047 for example has proposed an arrangement including a rib for smoothly linking the tray body with the side regulating plate. The arrangement disclosed in Japanese Patent Application Laid-open No. 2014-47047 prevents the sheet from slipping into the gap between the tray body and the side regulating plate by lifting the sheet that might slip into the gap between the tray body and the side regulating plate by the rib that smoothly links the tray body with the side regulating plate.

In the arrangement described in Japanese Patent Application Laid-open No. 2014-47047, however, the sheet may come into contact with the side regulating plate before the sheet contacts with the rib in a case where the sheet is set roughly on the tray like a case where the sheet is set on the tray obliquely with respect to a conveyance direction. In such a case, it is unable to lift the sheet by the rib, and the sheet may possibly slip into the gap between the tray body and the side regulating plate.

### SUMMARY OF THE INVENTION

According to one aspect of the present disclosure, a sheet supporting apparatus includes a sheet supporting portion including a support surface configured to support a sheet, and a pair of regulating portions provided on the sheet supporting portion and at least one of which is configured to be movable in a width direction orthogonal to a conveyance direction of a sheet, at least one of the pair of regulating portions including an abutment surface configured to be abuttable with the sheet in the width direction and an extension configured to extend from the abutment surface to a side in which the abutment surface abuts with the sheet. The support surface of the sheet supporting portion is bent in a support direction which is a direction orthogonal to the conveyance direction and the width direction at a position corresponding to the extension in the conveyance direction.

Further features of the present invention will become apparent from the following description of exemplary embodiments with reference to the attached drawings.

### BRIEF DESCRIPTION OF THE DRAWINGS

FIG. 1 is a schematic diagram illustrating a configuration of an image forcing apparatus according to an embodiment of the present disclosure.

FIG. 2 is a perspective view illustrating a sheet supporting apparatus according to the embodiment of the present disclosure.

FIG. 3 is a plan view illustrating a back surface of the sheet supporting apparatus of the embodiment of the present disclosure.

FIG. 4 is a perspective view illustrating a sheet supporting portion and a regulating portion of the embodiment of the present disclosure.

FIG. 5 is a section view illustrating a condition in which a sheet slips into a gap between a sheet supporting portion and a regulating portion of a sheet supporting apparatus of a comparative example.

FIG. 6 is a section view illustrating a condition in which the sheet supporting apparatus of the embodiment of the present disclosure supports a sheet.

### DESCRIPTION OF THE EMBODIMENTS

An image forming apparatus according to an embodiment of the present disclosure will be described below with reference to the drawings. The image forming apparatus of the present embodiment is what includes a sheet supporting apparatus configured to support and supply various sires of sheets such as a copier, a printer, a facsimile and a multifunction printer. It is noted that the following embodiment is one example to the end, and a person skilled in the art can appropriately modify a detailed configuration thereof for example within a scope not departing from a gist of the present disclosure. Still further, sizes, materials, shapes and their relative dispositions of components illustrated in the present embodiment are to be appropriately changed depending on a configuration of the apparatus and on carious conditions applicable to the present disclosure. The scope of the present disclosure is not limited only to them unless specified otherwise.

### EMBODIMENT

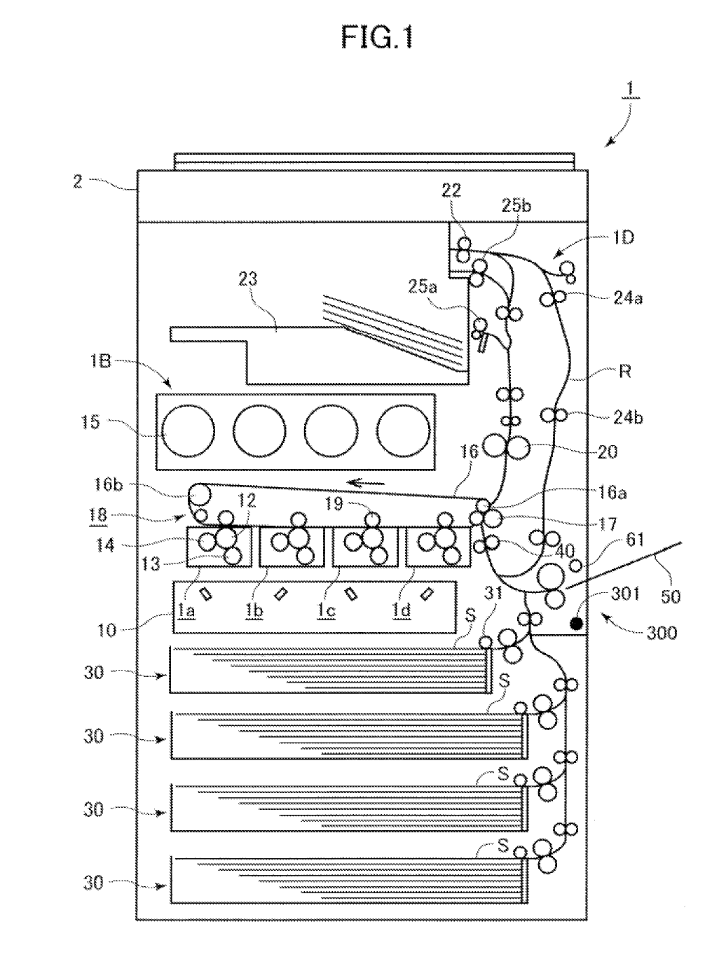

The image forming apparatus 1 illustrated in FIG. 1 includes an Image forcing portion 1B configured to form an image on a sheet S, a fixing portion 20 configured to fix the image on the sheet S and others within an apparatus body thereof. The image forming portion 1B is an electro-photographic image forming mechanism configured to be able to record in color and includes process cartridges 1a, 1b, 1c and 1d configured to form color toner images of yellow, magenta, cyan, and black, respectively. The image forming portion 1B also includes an exposure unit 10 and a transfer belt unit 18 and is configured to foe a so-called four-drum full color system.

The configurations of the process cartridges 1a, 1b, 1c and 1d are same except that their toner colors are different. Therefore, the configurations of the process cartridges 1a, 1b, 1c and 1d will be described below by mainly exemplifying the process cartridge 1a, and no description of the configurations of the process cartridges 1b, 1c and 1d will be made.

As illustrated in FIG. 1, the process cartridge 1a includes a photosensitive drum 12 serving as an image bearing member or an electro-photographic photoreceptor, a primary electrifier 13, and a developer 14. It is noted that although there is a case where the process cartridge 1a includes a toner cleaning mechanism and others besides a drive unit such as a motor not illustrated and driving the photosensitive drum 12, they are omitted in FIG. 1. Preferably, the process cartridges 1a, 1b, 1c and 1d are unitized and are configured such that they are attachable to/detachable from the image forming apparatus 1 per each cartridge. It is noted that there is also a case where parts of the developer 14 and the photosensitive drum 12 are configured to be a developer cartridge and a drum cartridge removable independently from each other.

Disposed under the process cartridges 1a, 1b, 1c and 1d is the exposure unit 10 composed of a laser light source configured to generate a recording light, a polygon mirror deflecting the recording light, and others. The photosensitive drums 12 of the respective process cartridges 1a, 1b, 1c and 1d are exposed by the recording light of the exposure unit 10, and an electrostatic latent image corresponding to each recording color is formed on a surface of the respective photosensitive drums.

In a case where the image forming apparatus 1 is constructed as a product having functions of a printer and a facsimile, an image signal inputted from a communication portion not illustrated is used to modulate the recording light of the exposure unit 10. Further, in a case where the image forming apparatus 1 is configured as a product having a function of a copier, an image signal read from a document by a scanner 2 disposed above the apparatus for example is used.

The electrostatic latent images on the surfaces of the respective photosensitive drums 12 of the process cartridges 1a, 1b, 1c and 1d are developed by toners of the respective developers 14 of the process cartridges 1a, 1b, 1c and 1d. The toners are supplied to the respective developers 14 from toner bottles 15 storing the respective color toners of yellow, magenta, cyan, and black and disposed respectively above the intermediate transfer belt 16.

A transfer belt unit 18 is disposed above the respective photosensitive drums 12 of the process cartridges 1a, 1b, 1c and 1d. The transfer belt unit 18 includes the Intermediate transfer belt 16 serving as an intermediate transfer body disposed in an arrangement of running through the process cartridges 1a, 1b, 1c and 1d in tandem in a right-left direction of FIG. 1.

The intermediate transfer belt 16 is wrapped around a driving roller 16a and a tension roller 16b and is disposed above the process cartridges 1a, 1b, 1c and 1d. The intermediate transfer belt 16 is rotated counterclockwise in FIG. 1 by the driving roller 16a driven by a drive portion net illustrated in a condition in contact with the respective photosensitive drums 12 of the process cartridges 1a, 1b, 1c and 1d. The transfer belt unit 18 includes primary transfer rollers 19 in contact with an inner circumferential surface of the intermediate transfer belt 16 at positions facing the respective photosensitive drums 12.

After drawing the electrostatic latent image by the exposure unit 10, a negatively electrified toner image of each color is formed on the surface of the photosensitive drum 12 by the toner supplied from the developer 14 in each of the process cartridges 1a, 1b, 1c and 1d.

Here, a color image formation process will be described. At first, a laser beam corresponding to an image signal of a yellow component color is projected onto the photosensitive drum 12 of the process cartridge 1a, i.e., the first image forming portion, from the exposure unit 10 to form the electrostatic latent image on the surface of the photosensitive drum 12. This electrostatic latent image is developed by yellow toner supplied from the developer 14 and is visualized as a yellow toner image.

As the photosensitive drum 12 rotates, the yellow toner image arrives at a primary transfer part where the photosensitive drum 12 is in contact with the intermediate transfer belt 16. The yellow toner image on the surface of the photosensitive drum 12 is primarily transferred onto the intermediate transfer belt 16 by a primary transfer bias applied to the primary transfer roller 19 at the primary transfer part.

With the rotation of the intermediate transfer belt 16, the part of the intermediate transfer belt 16 bearing the yellow toner image advances in a right direction in FIG. 1 and is moved to the position of the process cartridge 1b, i.e., the next image forming portion. By this moment, a magenta toner image has been formed on the surface of the photosensitive drum 12 of the process cartridge 1b by the same process with that of the abovementioned image forming portion. Then, the magenta toner image is superimposed and transferred onto the yellow toner image on the intermediate transfer belt 16 at another primary transfer part where the photosensitive drum 12 of the process cartridge 1b is in contact with the intermediate transfer belt 16. Then, along with the move of the intermediate transfer belt 16, the part of the intermediate transfer belt 16 bearing the yellow and magenta toner images is moved to the positions of the process cartridges 1c and 1d such that cyan and black toner images are transferred sequentially at respective primary transfer parts. Thus, the image forming apparatus 1 forms a full color toner image on the intermediate transfer belt 16.

Concurrently with such toner image forming process, the sheet S is conveyed. The image forming apparatus 1 is configured to be able to supply the sheet S from a cassette 30 disposed at a lower part of the image forming apparatus 1 and a manual sheet-feeding tray 50 provided in a swing door 300 pivotally supported centering on a shaft 301 so as to be turnable with respect to the image forming apparatus 1. In a case where the sheet S is to be supplied from the cassette 30, the image forming apparatus 1 is configured such that the sheet S supported by the cassette 30 is fed one by one by a pickup roller 31. In a case where the sheet S is to be supplied from the manual sheet-feeding tray 50, the image forming apparatus 1 is configured to feed the sheet S supported by the manual sheet-feeding tray 50 one by one by a pickup roller 61.

The sheet S fed one by one from the cassette 30 or the manual sheet-feeding tray 50 is conveyed to a registration roller pair 40 to correct a skew thereof in the image forming apparatus 1. Then, the registration roller pair 40 conveys the sheet S to a secondary transfer portion formed between the intermediate transfer belt 16 and a secondary transfer roller 17 by synchronizing with a transfer timing of the full color toner image formed on the intermediate transfer belt 16. The toner image born on the intermediate transfer belt 16 is secondarily transferred onto the sheet S by a positive bias voltage applied to the secondary transfer roller 17.

The sheet S onto which the toner image has been transferred is then conveyed to the fixing portion 20 and is heated and pressurized to fix the toner image onto the sheet S as a color image. The sheet S onto which the color image has been transferred is then discharged and supported on a discharge tray 23 by a discharge roller pair 25a.

Meanwhile, in a case where first and second images are to be formed on both surfaces of the sheet S, the sheet S on which the first image has been formed and which has passed through the fixing portion 20 is switched back by a reverse roller pair 25b provided in a reverse conveyance portion 1D and configured to be rotatable forward and backward. Then, the sheet S is conveyed through a re-conveyance path R along which a duplex upper roller pair 24a and a duplex lower roller pair 24b are disposed to the registration roller pair 40 again in a condition in which the surface on which the first image has been formed is reversed. After that, the second image is formed on the back of the sheet S by a same process with the process by which the first image has been formed on the surface, and the sheet S is then discharged onto the discharge tray 23. The duplex printing is thus completed.

It is noted that service lives of the process cartridges 1a through 1d and the transfer belt unit 18 are short due to their nature as compared to that of the image forming apparatus 1, so that they may be required to be replaced in order to fulfill the service life of the apparatus body. Therefore, it is desirable to configure the image forming apparatus 1 such that the both of the process cartridges 1a through 1d and the transfer belt unit 18 can be attachable/detachable to/from the image forming apparatus 1. This arrangement makes it possible to improve maintainability and to operate the whole image forming apparatus 1 for a long period of time.

The image forming apparatus 1 is also configured such that the sheet S can be readily removed in a case where a paper jam or the like occurs in the re-conveyance path R by opening the swing door 300.

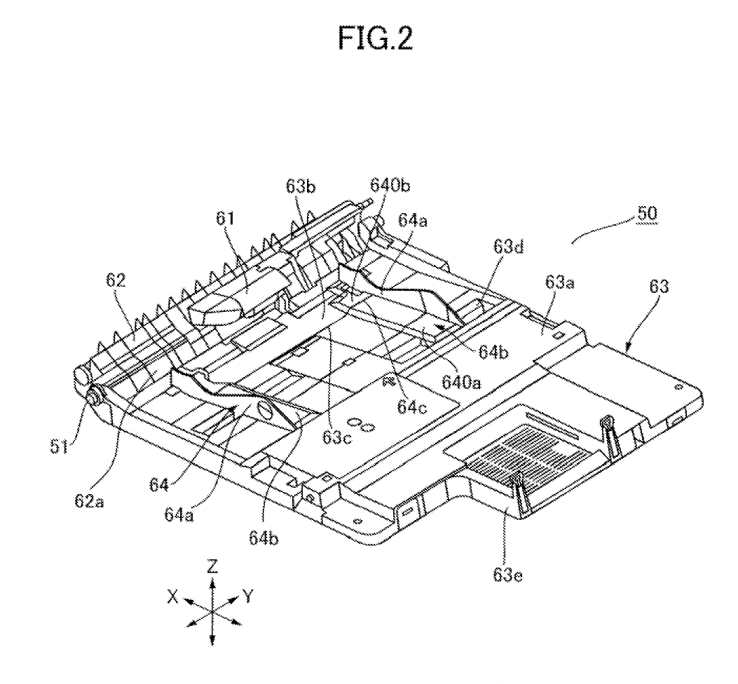

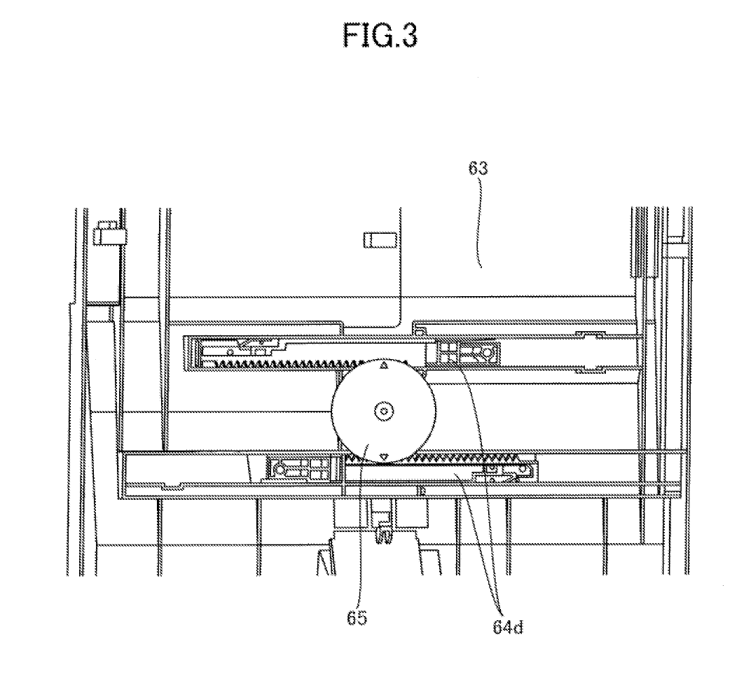

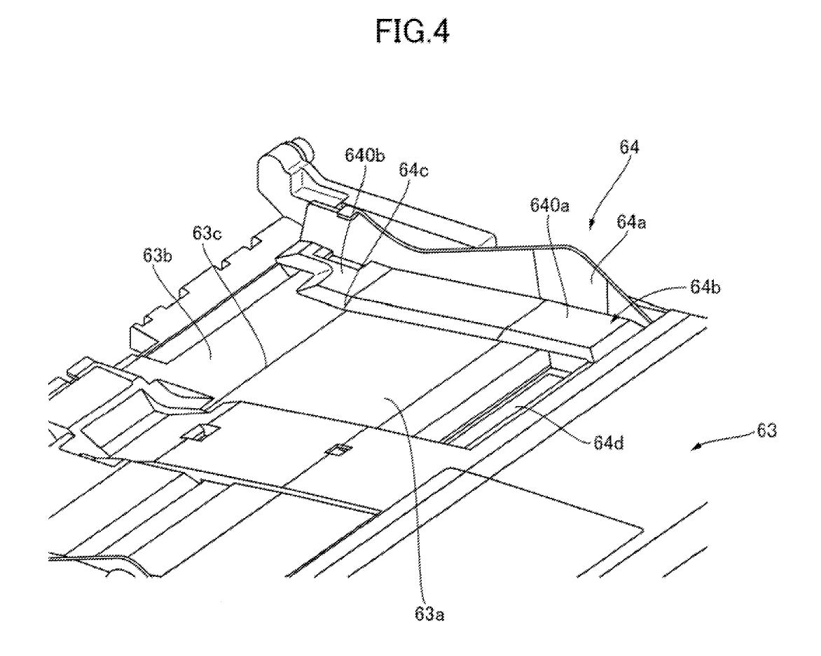

Next, the sheet supporting apparatus of the present embodiment will be described with reference to FIGS. 2 through 4. FIG. 2 is a perspective view illustrating a manual sheet-feeding tray 50 serving as the sheet supporting apparatus of the present embodiment, FIG. 3 illustrates a back surface of the manual sheet-feeding tray 50 of the present embodiment, and FIG. 4 is a perspective view illustrating a tray body 63 serving as the sheet supporting portion and a side regulating plate 64 serving as a regulating portion of the present embodiment.

As described above, the manual sheet-feeding tray 50 of the present embodiment is disposed in the swing door 300 pivotally supported centering on the shaft 301 so as to be turnable with respect to the image forming apparatus 1. The manual sheet-feeding tray 50 is pivotally supported so as to be turnable with respect to the swing door 300 centering on a shaft 51 and is operable with respect to the swing door 300. The manual sheet-feeding tray 50 is configured such that only one or a plurality of sheets S can be supported in a condition in which a leading edge, i.e., a downstream end, of the sheet S in the conveyance direction is butted against a butt portion 62a. The sheet S is fed one by one by a pickup roller 61 toward a conveyance path 62 provided in a conveyance direction X which is a direction in which the sheet S is conveyed.

The manual sheet-feeding tray 50 includes the tray body 63 configured to support the sheet S and a pair of the side regulating plates 64 provided on the tray body 63. The tray body 63 is formed into a shape of an approximately rectangular plate and includes a first support surface 63a configured to support and stack a plurality of sheets S on an upper surface thereof. The tray body 63 also includes a second support surface 63b disposed downstream in the sheet conveyance direction of the first support surface 63a. The second support surface 63b is formed continuously with the first support surface 63a through an intermediary of a bent portion 63c bent with respect to the first support surface 63a in a support direction Z which is a direction in which the sheet S is supported. Here, the support direction Z is a direction orthogonal to the conveyance direction X and to a width direction Y which is a widthwise direction of the sheet S orthogonal to the conveyance direction X.

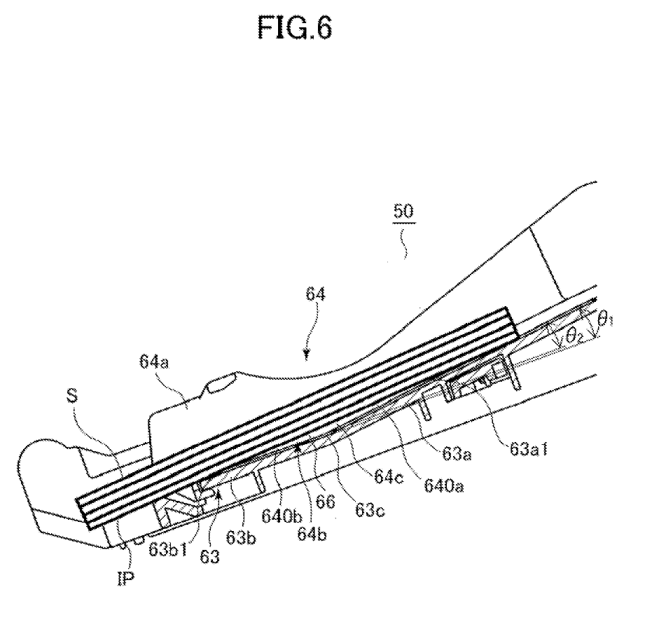

The first support surface 63a of the present embodiment is inclined such that the first support surface 63a is declined in the support direction Z from upstream to downstream in the conveyance direction. The first support surface 63a of the present embodiment is also bent in the support direction Z at the bent portion 63c such that a first bending angle θ1 which is an angle by which the first support surface 63a is bent in the support direction Z with respect to the second support surface 63b (see FIG. 6) becomes about seven degrees. That is, the manual sheet-feeding tray 50 is inclined to be declined in the support direction Z from upstream to downstream in the conveyance direction as a whole. Due to that, the first and second support surfaces 63a and 63b are inclined such that the closer to the upstream in the conveyance direction, the higher they are located respectively and such that inclination angles of the first and second support surfaces 63a and 63b are different from each other. The tray body 63 includes the bent portion 63c bent in the support direction Z at a position along the conveyance direction where an extension 64b of the side regulating plate 64 described later is provided. In other words, the first and second support surfaces 63a and 63b are provided with a first and second places 63a1 and 63b1, respectively, the closer to downstream in the conveyance direction, the more a portion of the first support surface 63a between the first place 63a1 and the bent portion 63c separates from an imaginary plane IP passing through the first place 63a1 and the second place 63b1, and the closer to the downstream in the conveyance direction, the more a portion of the second support surface 63b between the bent portion 63c and the second place 63b1 approaches the imaginary plane IP.

The tray body 63 also includes a rack groove 63d provided from the upper surface to an inside of the tray body 63 and extending in the width direction Y and an extension tray 63e provided upstream in the conveyance direction of the first support surface 63a and is configured to be manually extensible in the conveyance direction X. The manual sheet-feeding tray 50 can support and stack a sheet S which is longer than the first and second support surfaces 63a and 63b by the first and second support surfaces 63a and 63b and the extension tray 63e by extending the extension tray 63e in the conveyance direction X.

As illustrated in FIGS. 2 and 4, the side regulating plate 64 is configured to be movable in the width direction Y of the sheet S supported by the tray body 63 and to be able to regulate a position in the width direction Y of the sheet S by manually moving the side regulating plate 64 in the width direction Y after setting the sheet S on the tray body 63. Each of the pair of side regulating plates 64 includes an abutment surface 64a abuttable with the sheet S in the width direction Y and the extension 64b configured to extend from the abutment surface 64a to a side in which the abutment surface 64a abuts with the sheet S and to bring about a level difference with respect to the first and second support surfaces 63a and 63b of the tray body 63. Accordingly, in a case where the position in the width direction Y of the sheet S is regulated by the side regulating plate 64, the sheet S is supported by an upper surface of the extension 64b.

The abutment surface 64a erects at approximately right angles with respect to the extension 64b and regulates the widthwise position of the sheet S by abutting with the sheet S in the width direction Y. A downstream end in the conveyance direction of the abutment surface 64a and the extension 64b is located upstream in the conveyance direction of the abovementioned butt portion 62a against which the leading edge of the sheet supported on the manual sheet-feeding tray 50 butts, and a predetermined gap is provided between the abutment surface 64a and the extension 64b and the butt portion 62a. Therefore, the extension 64b is inserted under the supported sheet at a position between leading and trailing edges of the supported sheet in the conveyance direction, and the abetment surface 64a aligns the sheet widthwise position.

The extension 64b extends approximately in parallel with the tray body 63. The extension 64b includes a first extension portion 640a inclined so as to be declined in the support direction Z from upstream to downstream in the conveyance direction along the first support surface 63a and a second extension portion 640b disposed downstream in the sheet conveyance direction of the first extension portion 640a and formed continuously from the first extension portion 640a along the second support surface 63b. Here, the second extension portion 640b is formed continuously from the first extension portion 640a through an extension bent portion 64c and is bent with respect to the first extension portion 640a in the support direction Z which is the direction in which the sheet S is supported. That is, the first and second extension portions 640a and 640b are inclined such that the closer to upstream in the conveyance direction, the higher they are located respectively and such that inclination angles of the first and second extension portions 640a and 640b are different from each other. That is, the extension 64b is provided, such that the extension 64b includes the extension bent portion 64c at the position facing the bent portion 63c of the tray body 63 in the support direction Z. It is noted that the second extension portion 640b is formed such that a widthwise inner edge thereof is sharp. More specifically, the widthwise inner edge of the second extension portion 640b is formed as an inclined surface inclined downward toward the widthwise inner side, and this inclined surface serves as a slope guiding the sheet to the upper surface of the second extension portion 640b.

The first extension portion 640a of the present embodiment is bent in the support direction Z at the extension bent portion 64c such that a second bending angle θ2 which is an angle by which the first extension portion 640a is bent in the support direction Z with respect to the second extension portion 640b (see FIG. 6) is about seven degrees. That is, the first extension portion 640a of the present embodiment extends such that the second bending angle θ2 is equal to the first bending angle θ1 and such that the first extension portion 640a is approximately in parallel with the first support surface 63a.

As illustrated in FIG. 3, the side regulating plate 64 includes the rack portion 64d extending in the width direction Y from the extension 64b and configured to be movable in the width direction Y in a manner of being guided by the rack groove 63d. Rack teeth are formed in the rack portion 64d and are engaged with a pinion 65 provided in the manual sheet-feeding tray 50. The pinion 65 is provided commonly for the rack portions 64d provided for each of the pair of side regulating plates 64. Therefore, the manual sheet-feeding tray 50 is configured such that the pair of side regulating plates 64 is movable in linkage inside and outside in the width direction Y of the sheet S by rotating the pinion 65. It is noted that a side regulating mechanism configured to regulate the widthwise position of the sheet is constructed by the side regulating plates 64, the rack portion 64d and the pinion 65. The side regulating plates 64 may be configured such that one of the right and left side regulating plates is fixed and the other one is movable. In this case, the extension 64b may be provided only to the movable side regulating plate 64.

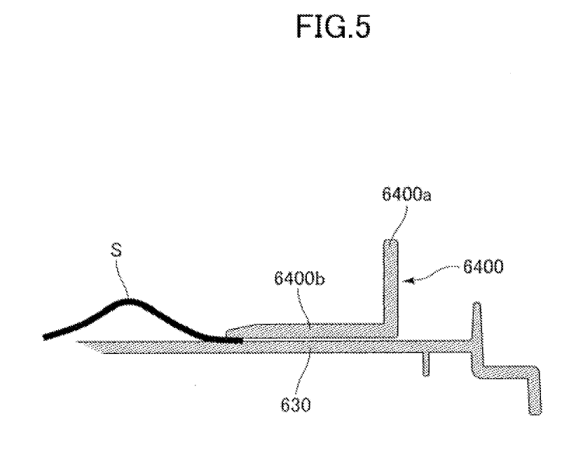

Next, a case where the sheet S is supported on the manual sheet-feeding tray 50 of the present embodiment and the position in the width direction Y of the sheet S is regulated by the side regulating plate 64 will be described with reference to FIGS. 5 and 6. FIG. 5 is a section view illustrating a case where a tray body 630 and an extension 6400b of a side regulating plate 6400 are formed without any bent portion, differing from the manual sheet-feeding tray 50 of the present embodiment. As illustrated in FIG. 5, in a case where the sheet S is supported by the tray body 630 including no bent portion and the widthwise position of the sheet S is regulated by the side regulating plate 6400, there is a possibility that the sheet S slips into a gap or a backlash generated between the tray body 630 and the extension 6400b.

FIG. 6 is a section view illustrating a case where sheet S is supported directly on the tray body 63, i.e., such that the sheet S contacts only with the tray body 63 without the intermediary of the extension 64b. The manual sheet-feeding tray 50 of the present embodiment is configured such that the tray body 63 is bent in the support direction Z so that a space 66 is assured between the sheet S and the tray body 63 in the case where sheet S is supported directly by the tray body 63 as illustrated in FIG. 6. Therefore, in the manual sheet-feeding tray 50, the sheet S does not come into contact entirely with the first support surface 63a in the case where the sheet S is supported directly by the tray body 63, and the space 66 is created between the sheet S and the first and second support surfaces 63a and 63b in a position including the bent portion 63c in the conveyance direction X.

Because the space 66 is created between the first and second support surfaces 63a and 63b, the extension 64b enters the space 66 in the case where the side regulating plate 64 is moved to regulate the widthwise position of the sheet S in the manual sheet-feeding tray 50. This arrangement makes it possible to scoop up an under surface of the sheet S by the extension bent portion 64c of the side regulating plate 64 even if the sheet S is roughly set on the tray body 63 such that the sheet S is obliquely placed. Accordingly, it is possible to prevent the sheet S from slipping into the gap generated between the tray body 63 and the side regulating plate 64 in the manual sheet-feeding tray 50 of the present embodiment.

As described above, according to the manual sheet-feeding tray 50 of the present disclosure, the sheet support surface of the tray body 63 is bent in the support direction Z at the position where the extension 64b of the side regulating plate 64 is provided along the conveyance direction of the tray body 63 configured to support the sheet S. This configuration creates the space 66 where the sheet S does not come into contact with the tray body 63 along the position where the extension 64b is provided in the conveyance direction in supporting the sheet S by the tray body 63. This arrangement makes it possible to configure the manual sheet-feeding tray 50 such that the extension 64b can be inserted into the space 66 when the side regulating plate 64 is moved and to prevent the sheet S from slipping into the gap between the tray body 63 and the side regulating plate 64.

It is noted that while the tray body 63 is configured each that the first and second support surfaces 63a and 63b are formed linearly and are angled at the bent portion 63c in the present embodiment, the present disclosure is not limited to such configuration. For instance, the tray body 63 may be configured such that the sheet support surface is formed into a shape bent in the support direction Z by curving the support surface in the support direction Z. This configuration makes it possible to scoop up the under surface of the sheet S by the extension 64b because the side regulating plate 64 includes the extension 64b at a part along the conveyance direction X including the position where the space 66 is created when the sheet S is set on the tray body 63.

Still further, while the tray body 63 includes the bent portion 63c at one place along the conveyance direction X in the present embodiment, the present disclosure is not limited to such configuration. The tray body 63 may be configured so as to have a plurality of bent portions along the conveyance direction X. In a case where the tray body 63 is configured as described above, the side regulating plate 64 may include the extension 64b that faces at least one of the plurality of bent portions in the support direction Z.

Still further, while the extension 64b is configured such that the first and second extension portions 640a and 640b extend to the side in which the abutment surface 64a abuts with the sheet in the present embodiment, the present disclosure is not limited to such configuration. The extension 64b just needs to be provided so as to include the position facing the bent portion 63c in the support direction Z, and a part of the first extension portion 640a may extend to a side in which the abutment surface 54a does not abut with the sheet for example. The extension 64b may be also configured such that a part of the second extension portion 640b extends to the side in which the abutment surface 64a does not abut with the sheet for example.

Still further, while the manual sheet-feeding tray 50 is configured such that the first bending angle θ1 is equal to the second bending angle θ2 in the present embodiment, the present disclosure is not limited to such configuration and the manual sheet-feeding tray 50 may be configured such that the first and second bending angles θ1 and θ2 are different from each other. That is, the first extension portion 640a needs not be in parallel with the first support surface 63a, and the second extension portion 640b needs not be in parallel with the second support surface 63b. Still further, the second support surface 63b needs not be always inclined so as to be declined in the support direction Z from upstream to downstream in the conveyance direction. The second support surface 63b just needs to be inclined relatively with respect to the first support surface 63a and may be formed so as to extend in a horizontal direction for example.

Although the extension 64b is formed such that the edge portion thereof is sharpened in the present embodiment, the present disclosure is not limited to such configuration and the edge portion of the extension 64b may be formed into any shape.

Although the side regulating mechanism of the present embodiment is configured such that the both of the pair of side regulating plates 64 move in linkage as the pinion 65 that engages with the rack portions 64d rotates, the present disclosure is not limited to such configuration. The side regulating mechanism may be composed of a side regulating plate movable in the width direction Y and a side regulating plate fixed to the tray body 63. In a case where the side regulating mechanism is configured as described above, preferably the side regulating plate movable in the width direction Y includes the extension.

Still further, while the present embodiment has been described by using the manual sheet-feeding tray 50 as a typical example, the present disclosure is also applicable to a support portion configured to support a document and to a regulating portion provided in an image reading apparatus configured to read an image of the document. The present disclosure is applicable to any configuration as long as the configuration includes a component configured to support a thin sheet and a component configured to regulate a widthwise position of the supported sheet.

While the present invention has been described with reference to exemplary embodiments, it is to be understood that the invention is not limited to the disclosed exemplary embodiments. The scope of the following claims is to be accorded the broadest interpretation so as to encompass ail such modifications and equivalent structures and functions.

This application claims the benefit of Japanese Patent Application No. 2016-240536, filed Dec. 12, 2016, which is hereby incorporated by reference wherein in its entirety.

What is claimed is:

1. A sheet supporting apparatus, comprising:
a sheet supporting portion including a support surface configured to support a sheet; and
a pair of regulating portions provided on the sheet supporting portion and at least one of which is configured to be movable in a width direction orthogonal to a conveyance direction of the sheet, at least one of the pair of regulating portions including an abutment surface configured to be abut table with the sheet in the width direction and an extension configured to extend from the abutment surface to a side in which the abutment surface abuts with the sheet,
wherein the support surface of the sheet supporting portion is bent in a support direction which is a direction orthogonal to the conveyance direction and the width direction at a position corresponding to the extension in the conveyance direction.

2. The sheet supporting apparatus according to claim 1, wherein the support surface of the sheet supporting portion includes a first support surface and a second support surface disposed downstream in the conveyance direction of the first support surface and is formed continuously from the first support surface through a bent portion bent in the support direction.

3. The sheet supporting apparatus according to claim 2, wherein the extension includes a first extension portion formed along the first support surface and a second extension portion disposed downstream in the conveyance direction of the first extension portion and formed along the second support surface.

4. The sheet supporting apparatus according to claim 1, wherein the regulating portion supports the sheet by an upper surface of the extension in a case where the regulating portion regulates the position in the width direction of the sheet.

5. The sheet supporting apparatus according to claim 1, wherein the support surface of the sheet supporting portion is bent in the support direction such that a space is created between the sheet and the sheet supporting portion in a case when the sheet is directly supported on the sheet supporting portion.

6. The sheet supporting apparatus according to claim 1, wherein the support surface of the sheet supporting portion includes a first support surface provided with a first place, and a second support surface provided with a second place and disposed downstream in the conveyance direction of the first support surface and connected to the first support surface through a bent portion,
wherein the closer to downstream in the conveyance direction, the more a portion of the first support surface between the first place and the bent portion separates from an imaginary plane passing through the first place and the second place, and
wherein the closer to the downstream in the conveyance direction, the more a portion of the second support surface between the bent portion and the second place approaches the imaginary plane.

7. The sheet supporting apparatus according to claim 6, wherein the extension includes a first extension portion formed along the first support surface and a second extension portion disposed downstream in the conveyance direction of the first extension portion and formed along the second support surface.

8. An image forming apparatus comprising the sheet supporting apparatus as set forth in claim 1; and
an image forming portion configured to form an image on the sheet fed from the sheet supporting apparatus.
